(19) United States
(12) Patent Application Publication
(10) Pub. No.: US 2015/0070262 A1
(43) Pub. Date: Mar. 12, 2015

(54) CONTEXTUAL ANNOTATIONS OF A MESSAGE BASED ON USER EYE-TRACKING DATA

(71) Applicants: Richard Ross Peters, Mill Valley, CA (US); Amit V. Karmarkar, Palo Alto, CA (US)

(72) Inventors: Richard Ross Peters, Mill Valley, CA (US); Amit V. Karmarkar, Palo Alto, CA (US)

(21) Appl. No.: 14/021,043

(22) Filed: Sep. 9, 2013

(51) Int. Cl. G06F 3/01; G02B 27/01

(52) U.S. Cl. CPC G06F 3/013; G02B 27/017
USPC 345/156

(57) ABSTRACT

In one exemplary embodiment, a method includes the step of receiving eye tracking information associated with eye movement of a user of a computing system from an eye tracking system coupled to a computing system The computing system is in a messaging mode of operation and is displaying an element of a message. Based on the eye tracking information, is determined that a path associated with the eye movement associates an external object with a portion of the message. Information about the external object is automatically associated with the portion of the message.

### CROSS-REFERENCE TO RELATED APPLICATIONS

This application is a continuation-part of and claims priority to U.S. patent application Ser. No. 13/208,184 filed Aug. 11, 2011. U.S. patent application Ser. No. 13/208,184 application claims priority from U.S. Provisional Application No. 61/485,562, filed May 12, 2011; U.S. Provisional Application No. 61/393,894, filed Oct. 16, 2010; and U.S. Provisional Application No. 61/420,775, filed Dec. 8, 2010. The 61/485,562, 61/393,894 and 61/420,775 provisional applications and the Ser. No. 13/208,184 non-provisional application are hereby incorporated by reference in their entirety for all purposes. This application is also a continuation-in-part of and claims priority from currently pending patent application Ser. No. 12/422,313 filed on Apr. 13, 2009 which claims priority from provisional application 61/161,763 filed on Mar. 19, 2009, patent application Ser. No. 12/422,313 is a continuation-in-part of Ser. No. 11/519,600 filed Sep. 11, 2006, which was patented as U.S. Pat. No. 7,551,935, which is a continuation-in-part of Ser. No. 11/231,575 filed Sep. 21, 2005 which was patented as U.S. Pat. No. 7,580,719. Furthermore, this application claims priority to U.S. Provisional Patent Ser. No. 61/716,539, filed Oct. 21, 2012. This provisional application is herein incorporated by reference.

### BACKGROUND OF THE INVENTION

1. Field

This application relates generally to electronic messaging, and more specifically to a system, article of manufacture, and method for contextual annotations of a message based on user eye-tracking data.

2. Related Art

Bioresponse data may be collected from a variety of devices and sensors that are becoming more and more prevalent today, Laptops frequently include microphones and high-resolution cameras capable of monitoring a person's facial expressions, eye movements, or verbal responses while viewing, or experiencing media. Cellular telephones now include high-resolution cameras, proximity sensors, accelerometers, and touch-sensitive screens (galvanic skin response) in addition to microphones and buttons, and these “smartphones” have the capacity to expand the hardware to include additional sensors. Moreover, high-resolution cameras are decreasing in cost, making them prolific in is variety of applications ranging from user devices like laptops and cell phones to interactive advertisements in shopping malls that respond to mall patrons proximity and facial expressions. The capacity to collect biological responses from people interacting with digital devices is thus increasing dramatically.

Interaction with digital devices has become more prevalent concurrently with a dramatic increase in electronic communication such as email, text messaging, and other forms. The bioresponse data available from some modern digital devices and sensors, however, has not been used in contemporary user interfaces for text parsing and annotation. Typical contemporary parser and annotation mechanisms use linguistic and grammatical frameworks that do not involve the user physically. Also, contemporary mechanisms often provide information regardless of whether the composer needs or wants it and, thus, are not customized to the user.

There is therefore a need and an opportunity to improve the relevance, timeliness, and overall quality of the results of parsing and annotating, text messages using bioresponse data.

### BRIEF SUMMARY OF THE INVENTION

In one exemplary embodiment, a method includes the step of receiving eye tracking information associated with eye movement of a user of a computing, system from an eye tracking system coupled to a computing system. The computing system is in a messaging mode of operation and is displaying an element of a message. Based on the eye tracking information, is determined that a path associated with the eye movement associates an external object with a portion of the message. Information about the external object is automatically associated with the portion of the message.

### BRIEF DESCRIPTION OF THE DRAWINGS

FIG. 1 illustrates an exemplary process 100 for linking context data to portions of a text message;

FIG. 2 illustrates a side view of illustrates a front view of an augmented-reality glass in an example eyeglasses embodiment;

FIG. 3 depicts an exemplary computing system configured to perform any one of the processes described herein, according to an example embodiment;

FIG. 4 illustrates a process of linking a context data with a portion of a message, according to some embodiments;

FIG. 5 illustrates a method of linking a series of digital images with a user-composed message, according to some embodiments;

FIG. 6 depicts a process 600 of composing an electronic message, according to some embodiments;

FIGS. 7A-C illustrate example methods for generating a context-enriched message with user eye-tracking data, according to some embodiments;

FIG. 8 illustrates another example method for generating a context-enriched message with user eye-tracking data, according to some embodiments;

FIG. 9 illustrates another block diagram of a sample computing environment with which embodiments may interact;

FIG. 10 is a diagram illustrating an exemplary system environment configured to perform any one of the above-described processes.

### DETAILED DESCRIPTION OF THE INVENTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the broadest scope consistent with the claims.

This disclosure describes techniques that may collect bioresponse data from a user while text is being composed, adjust the level of parsing and annotation to user preferences, comprehension level, and intentions inferred from bioresponse data, and/or respond dynamically to changes in user thought processes and bioresponse-inferred states of mind.

Bioresponse data may provide information about a user's thoughts that may be used during composition to create an interactive composition process. The composer may contribute biological, responses (e.g., eye-tracking saccades, fixations, or regressions) during message composition. These biological responses may be tracked, the utility of additional information to the user may be validated, and system responses (e.g., parsing/linguistic frameworks, annotation creation, and display) may be determined. This interaction may result in a richer mechanism for parsing and annotation, and a significantly more dynamic, timely, customized, and relevant system response.

Disclosed are a system, method, and article of manufacture for causing an association of information related to a portion of a text message with the identified portion of the

Although the present embodiments have been described with reference to specific example embodiments, it will be evident that various modifications and changes may be made to these embodiments without departing from the broader spirit and scope of the various claims.

Biological responses may be used to determine the importance of a word or a portion of a text message. For example, a word may be a “filler” word in some contexts, but could be an “information-laden” word in others. For example, the word “here” in the sentence “Flowers were here and there” is an idiom which connotes a non-specific place (e.g., something scattered all over the place), and has no implication of specific follow-through information. Conversely, in the sentence “Meet me here,” the word “here” has a specific implication of follow-through information.

One aspect of this disclosure is that the user's eye tracking data (and/or bioresponse data) may reflect which words are filler-words and which are “information-heavy” words. These words may be associated with relevant information e.g. context data from user's environment, digital images, and the like). For example, the relevant information can be context data that augments and/or supplements the intended meaning of the word.

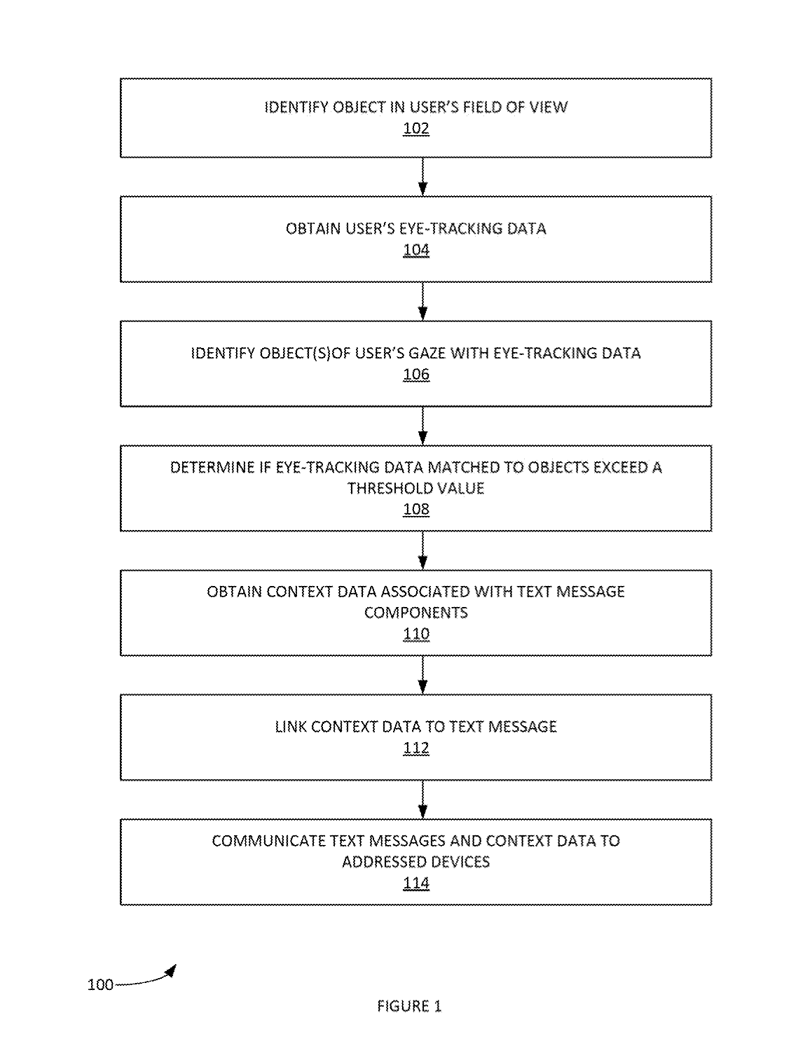

FIG. 1 illustrates an exemplary process 100 for linking context data to portions of a text message. Process 100 may be used to generate and transmit a context-enriched text message to a text-messaging application in another device.

In step 102 of process 100, an object in a user's field of view can be identified. For example, the user may have a computing device (e.g. a tablet computer, a head mounted gaze tracking device (e.g. Google Glass®, etc.), a smart phone, and the like) that includes an outward facing, camera and/or a user facing camera with an eye-tracking tracking system. A digital image/video stream from the outward facing camera can be obtained and compared with the user's eye-tracking data to determine a user's field of view. Various computer vision techniques (e.g., image recognition, image registration and the like) can be utilized identify objects in the user's field of view. A log of identified objects can be maintained along with various metadata information relevant to the identified object (c..g, location of identified object, other computing device sensor data, computing device operating system information, information about other objects recognized in temporal, gaze and/or location-based sequenced with the identified object.).

In step 104, the user's eye tracking can be obtained. Information about the user's eye-tracking data (e.g., associated object the user is looking at, length of fixations, saccadic velocity, pupil dilation, number of regressions, etc.) can be stored in a log. In step 106, the objects of as user's gaze can be identified using the user's eye tracking data.

In step 108, it can be determine if the eye-tracking data (and/or other bioresponse data in some embodiments) exceeds a threshold value with respect to an identified object. For example, a threshold value can be a set of eye-tracking data that indicates an interest by the user in the identified object (e.g. a fixation of a specified length, a certain number of regressions back to the identified object within a specified period of time, and the like).

A user may be composing a text message (e.g. an augmented reality message, a short messaging system message (SMS), a multimedia system message (MMS), etc.). In one embodiment, a user can use a voice-to-text functionality in the computing device to generate the text message. In another embodiment, the user can compose a text message with another computing device that is communicatively paired with the displaying computing device. For example, a text message can be composed with a smart phone and displayed with a wearable computer with an optical head-mounted display (OHMD). The text message can appear on a display of the OHMD. It is noted that in some embodiments, a voice message and/or video message can be utilized in lieu of a text message.

It is further noted that certain components of the text message (and/or voice or video message in some embodiments) is relevant to the identified object indicated by the user's eye-tracking data in step 108. Accordingly, in step 110, context data associated with text message components can be obtained. For example, the digital image of the identified object itself can be the context data. The digital image can be included in the text message and/or a hyperlink to the digital image can be associated with the text message component. In another example, a series of digital images can be associated with the text message component. For example, a set of stored digital images can be used to generate a 360 degree video of a scene relevant to the text message component. For example, a user can generate a text message: “This place is awesome”. Previous images of the current location of the user can have been obtained by the user's OHMD. These images can be automatically used to generate a substantially 360 video/image of the current location and linked to the user's text message. In another example, a preset series of user eye movements can be implemented by the user to link a context data associated with an external object (e.g. the identified object) and the portion of the text message. Identified objects can be also be associated with sensors that are obtained relevant physical environmental, context data. For example, if the user is looking at a snowman a temperature sensor in the OHMD can obtain the ambient temperature. A frontal facing camera in the OHMD can obtain an image of the snowman. The ambient temperature and/or the image of the snowman can be linked to a text message component referencing the snowman. This linkage can be automatic (e.g. as inferred from the identity of the snowman in the digital image and the use of the word ‘snowman’ in the text message and/or manually indicated by a specified eye-tracking pattern on the part of the user (e.g. looking at the text ‘snowman’ for as set period, followed by looking at the real snowman for a set period). Other user gestures (e.g. blinking, head tilts, spoken terms) can be used in lieu of and/or in combination with eye-tracking patterns to indicate linking the context data and the text message component. Thus, in step 112, the context data can be linked (e.g. appended) with the text message.

In step 114, the text message and the context data can be communicated to the addressed device. It is noted that, some embodiments, the text message can be sent to a non-user device such as a server. For example, the text message can be used to annotate an e-book, generate a microblog post, post an image to a pinboard-style photo-sharing website (e.g. Pinterest®, etc.), provide an online social networking website status update, comment on a blog post, etc. Thus, the text message can be transformed into viewed data that may take the form of a text message, webpage element, instant message, email, social networking status update, micro-blog post, blog post, video, image, or any other digital document. The bioresponse data may be eye-tracking data, heart rate data, hand pressure data, galvanic skin response data, or the like. A webpage element may be any element of a webpage document that is perceivable by a user with a web browser on the display of a computing device, it is noted that various steps of process 100 can be performed in a server (e.g. a cloud-computing server environment). For example, data from the computing device (e.g. camera streams, eye-tracking data, accelerometer data, other sensor data, other data provided supra) can be communicated to the server where portions of the various steps of process 100 can be performed.

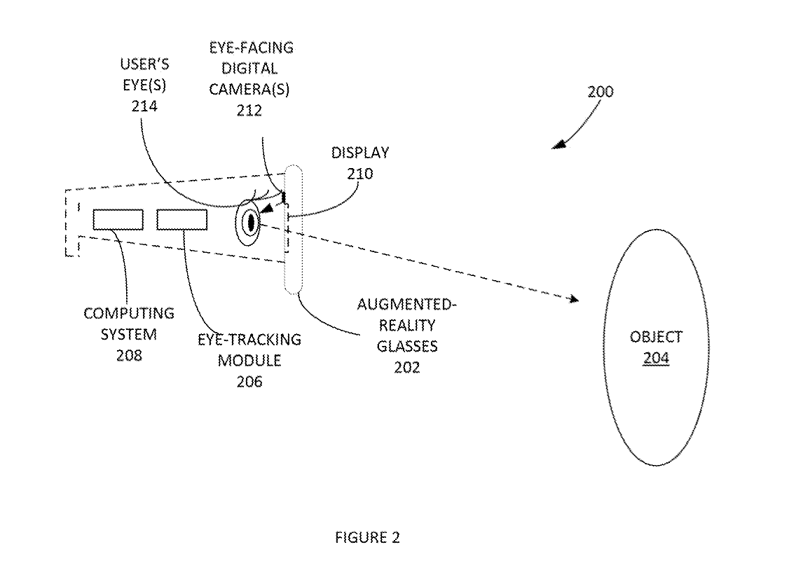

FIG. 2 illustrates a side view of illustrates a front view of an augmented-reality glasses 202 in an example eyeglasses embodiment. Although this example embodiment is provided in an eyeglasses format, it will be understood that wearable systems may take other forms, such as hats, goggles, masks, headbands and helmets. Augmented-reality glasses 202 may include an OH MD. Extending side arms may be affixed to the lens frame. Extending side arms may be attached to a center frame support and lens frame. Each of the frame elements and the extending side-arm may be formed of a solid structure of plastic or metal, or may be formed of a hollow structure of similar material so as to allow wiring and component interconnects to be internally routed through the augmented-reality glasses 202.

A lens display may include lens elements that may be at least partially transparent so as to allow the wearer to look through lens elements. In particular, a user's eye 204 of the wearer may look through a lens that may include display 206. One or both lenses may include a display. Display 206 may be included in the augmented-reality glasses 202 optical systems. In one example, the optical systems may be positioned in front of the lenses, respectively. Augmented-reality glasses 202 may include various elements such as a computing system 208, user input device(s) such as a touchpad, a microphone, and a button. Augmented-reality glasses 202 may include and/or be communicatively coupled with other biosensors (e.g. with NFC, Bluetooth®, etc.). The computing system 208 may manage the augmented reality operations, as well as digital image and video acquisition operations. Computing system 208 may include a client for interacting with a remote server (e.g. augmented-reality (AR) messaging service, other text messaging service, image/video editing service, etc.) in order to send user bioresponse data (e.g. eye-tracking data, other biosensor data) and/or camera data and/or to receive information about aggregated eye tracking/bioresponse data (e.g., AR messages, and other data). For example, computing system 208 may use data from among other sources, various sensors and cameras (e.g. outward facing camera that obtain digital images of object 204) to determine a displayed image that may be displayed to the wearer. Computing system 208 may communicate with a network such as a cellular network, local area network and/or the Internet. Computing system 208 may support an operating system such as the Android™ and/or Linux operating system.

The optical systems may be attached to the augmented reality glasses 202 using support mounts. Furthermore, the optical systems may be integrated partially or completely into the lens elements. The wearer of augmented reality glasses 202 may simultaneously observe from display 206 a real-world image with an overlaid displayed image. Augmented reality glasses 202 may also include eye-tracking system(s) that may be integrated into the display 206 of each lens. Eye-tracking system(s) may include eye-tracking module 210 to manage eye-tracking operations, as well as, other hardware devices such as one or more a user-facing cameras and/or infrared light source(s). In one example, an infrared light source or sources integrated into the eye-tracking system may illuminate the eye of the wearer, and a reflected infrared light may be collected with an infrared camera to track eye or eye-pupil movement.

Other user input devices, user output devices, wireless communication devices, sensors, and cameras may be reasonably included and/or communicatively coupled with augmented-reality glasses 202. In some embodiments, augmented-reality glass 202 may include a virtual retinal display (VRD). Computing system 208 can include spatial sensing sensors such as a gyroscope and/or an accelerometer to track direction user is facing and what angle her head is at.

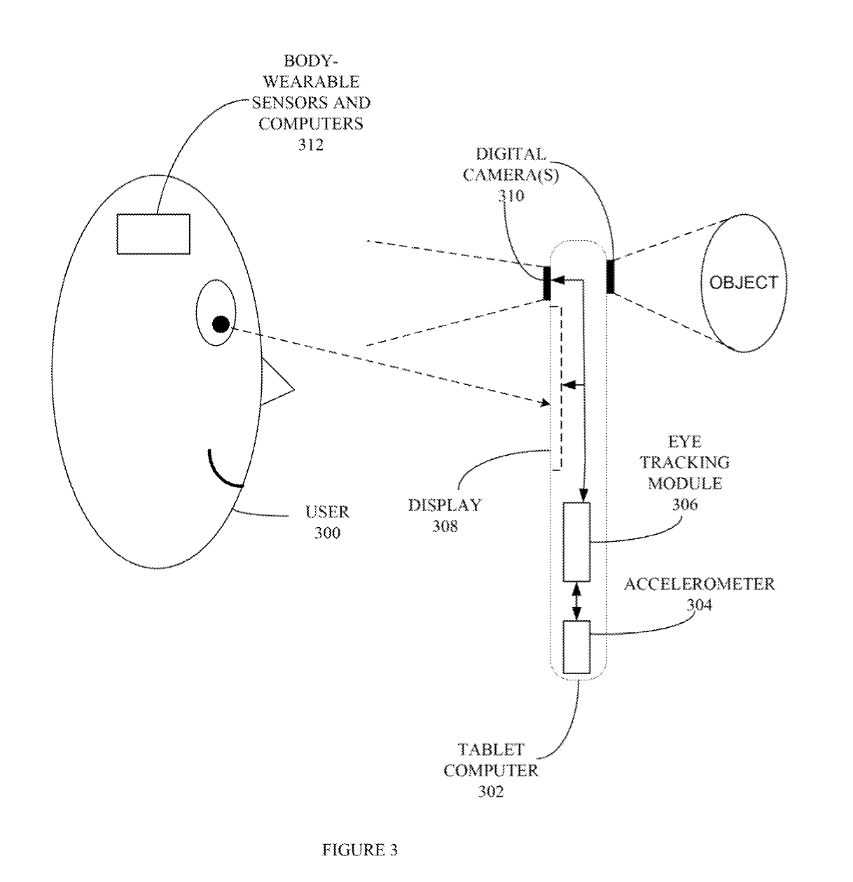

FIG. 3 illustrates one example of obtaining bioresponse data from a user viewing, a digital document (such as a text message) and/or an object via a computer display and an outward facing camera. In one embodiment, eye-tracking module 340 of user device 310 tracks the gaze 360 of user 300. Although illustrated here as a generic user device 310, the device may be a cellular telephone, personal digital assistant, tablet computer (such as an iPad®), laptop computer, desktop computer, or the like. Eye-tracking module 340 may utilize information from at least one digital camera 320 (outward and/or user-facing) and/or an accelerometer 350 (or similar device that provides positional information of user device 310) to track the user's gaze 360. Eye-tracking module 340 may map eye-tracking data to information presented on display 330. For example, coordinates of display information may be obtained from a graphical user interface (GUI). Various eye-tracking algorithms and methodologies (such as those described herein) may be used to implement the example shown in FIG. 3.

In some embodiments, eye-tracking module 340 may use an eye-tracking: method to acquire the eye movement pattern. In one embodiment, an example eye-tracking method may include an analytical gaze estimation algorithm that employs the estimation, of the visual direction directly from selected eye features such as irises, eye corners, eyelids, or the like to compute a gaze 360 direction. If the positions of any two points of the nodal point, the fovea, the eyeball center, or the pupil center can be estimated, the visual direction may be determined.

In addition, light may be included on the front side of user device 310 to assist detection of any points hidden in the eyeball. Moreover, the eyeball center may be estimated from other viewable facial features indirectly. In one embodiment, the method may model an eyeball as a sphere and hold the distances from the eyeball center to the two eye corners to be a known constant. For example, the distance may be fixed to 13 mm. The eye corners may be located (e.g., by using a binocular stereo system) and used to determine the eyeball center. In one exemplary embodiment, the iris boundaries may be modeled as circles in the image using a Hough transformation.

The center of the circular iris boundary may then be used as the pupil center. In other embodiments, a high-resolution camera and other image processing tools may be used to detect the pupil. It should be noted that, in some embodiments, eye-tracking module 340 may utilize one or more eye-tracking methods in combination. Other exemplary eye-tracking methods include: a 2D eye-tracking algorithm using a single camera and Purkinje image, a real-time eye-tracking algorithm with head movement compensation, a real-time implementation of a method to estimate gaze 360 direction using stereo vision, a free head motion remote eyes (REGT) technique, or the like. Additionally, any combination of any of these methods may be used. Body-wearable sensors 312 can be any sensor (e.g. biosensor, heart-rate monitor, galvanic skin response sensor, etc.) that can be worn by a User and communicatively coupled with tablet computer 302 and/or a remote server.

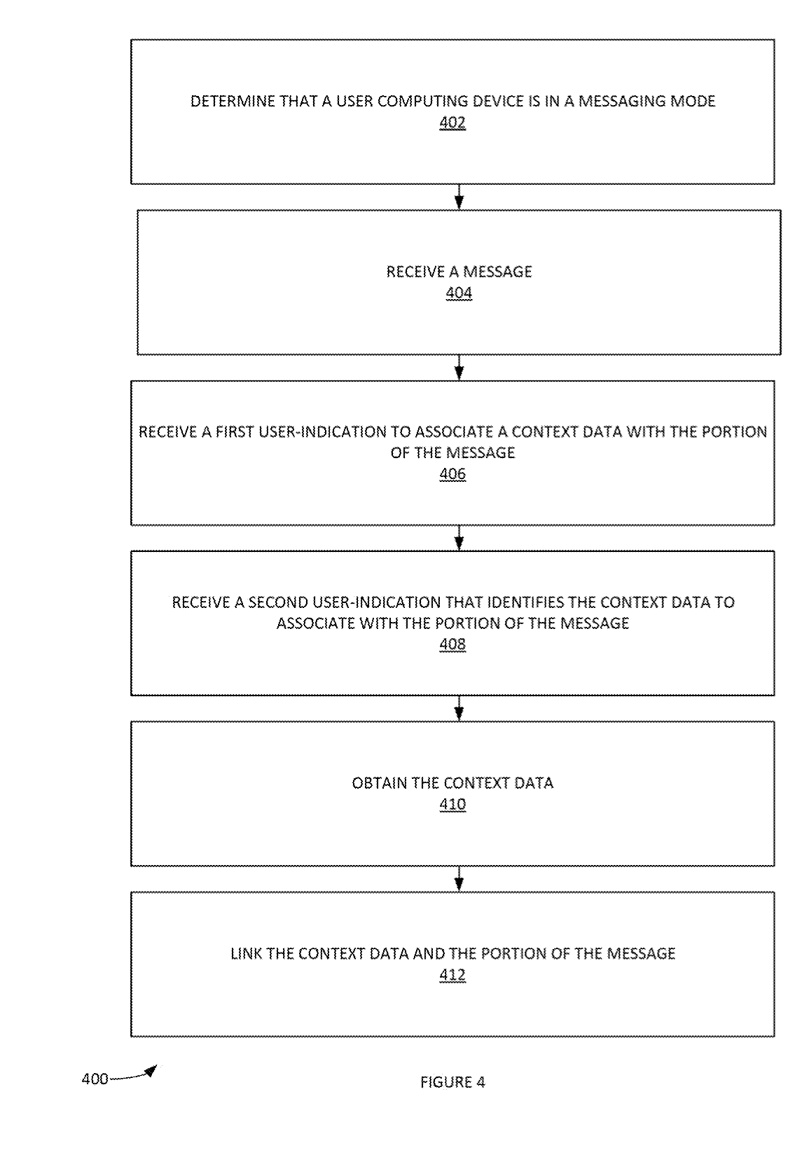

FIG. 4 illustrates a process 400 of linking a context data with a portion of a message, according to some embodiments. In step 402 of process 400, it is determined that a computing device is in messaging mode. In step 404, a message (e.g., a text message, a voice message, etc.) is received. In step 406, a first user-indication to associate a context data with the portion of the message. For example, eye-tracking systems, may indicate a coordinate location of a particular visual stimuli—like a particular word in a phrase or figure in an image that is a portion of the message—and associate the particular stimuli with the portion of the message. This association may enable a system to identify specific words, images, and other elements that elicited a measurable response from the person experiencing the message. For instance, a user reading a text message may quickly read over some words while pausing at others. When the eyes simultaneously pause and focus on a certain word for a longer duration than other words, this response may then be associated with the particular word the person was reading. This association of a particular word and a fixation of a specified length may cause the word to be identified. This user behavior may be interpreted as an indication to associate a context data with this portion of the message. For example, a user may reread a phrase in the message three times in a row to identify the portion of the message. In another example, the may fixate her gaze on a word for a specified period of time (e.g. one second, two seconds, etc.). In yet another example, a user may fixate her gaze on the word and blink. These indicators are provided by way of example and not of limitation.

In step 408, a second user-indication identifying the context data to associate with the portion of the message is received. For example, the user may gaze at an object (e.g. another person, a sign, a television set, etc.) for a fixed period of time. In some examples, the user may perform another action simultaneously with the gaze such as say a command; make a certain pattern of body movement; etc. Once the external object is identified, an outward facing camera and/or other sensors in the user's computing device can obtain context data about the object. Thus, in step 410, the context data is obtained. In step 412, the context data and the portion of the message can be linked. For example, the context data can in be included in the message. In another example., the context data can be stored in a server (e.g., a web server) and a pointer (e.g. a hyperlink) to the context data can be included in the message.

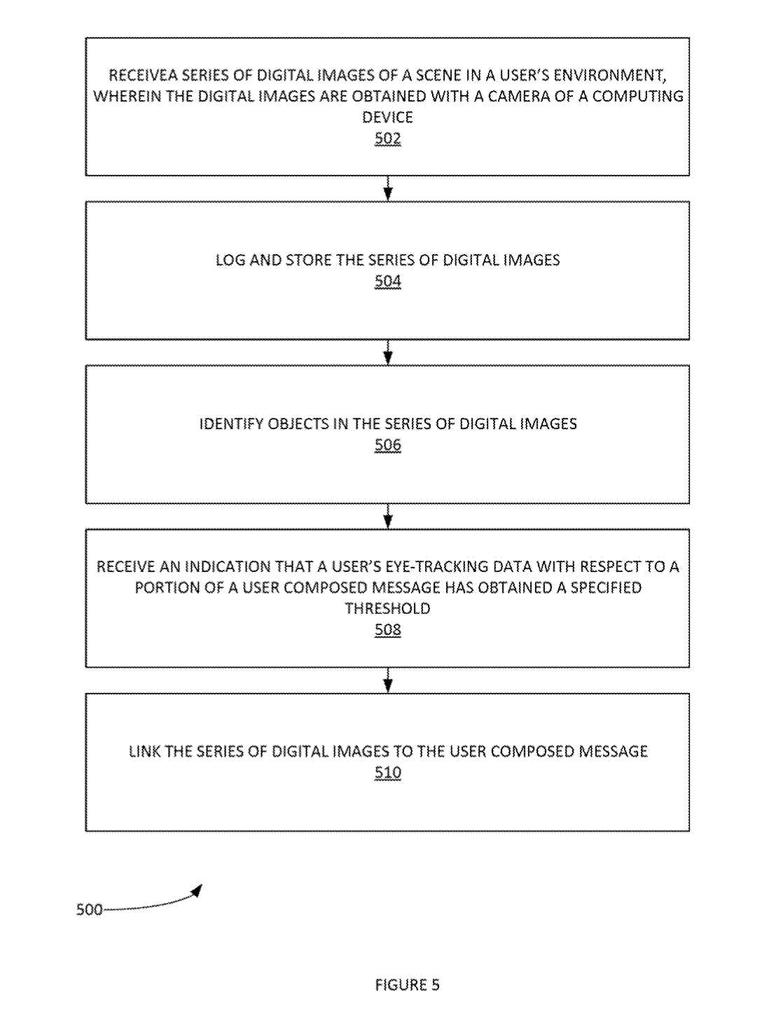

FIG. 5 illustrates a method 500 of linking a series of digital images with a user-composed message, according to some embodiments. In step 502, a series of digital images in a user's environment is received. The digital images can be obtained from a camera of a computing device (e.g. worn by the user). In step 504, the series of digital images can be logged and stored in a database. In step 506, objects in the digital images can be identified (e.g. with an image-recognition application). In step 508, an indication of a user's eye-tracking data (e.g. the user of the computing device with the camera) with respect to a portion of a user-composed message has obtained a specified threshold is received (e.g. the user has a fixation of a specified length on a word and/or image in the user-composed message). In step 510, the series of digital images can be linked to the user-composed message.

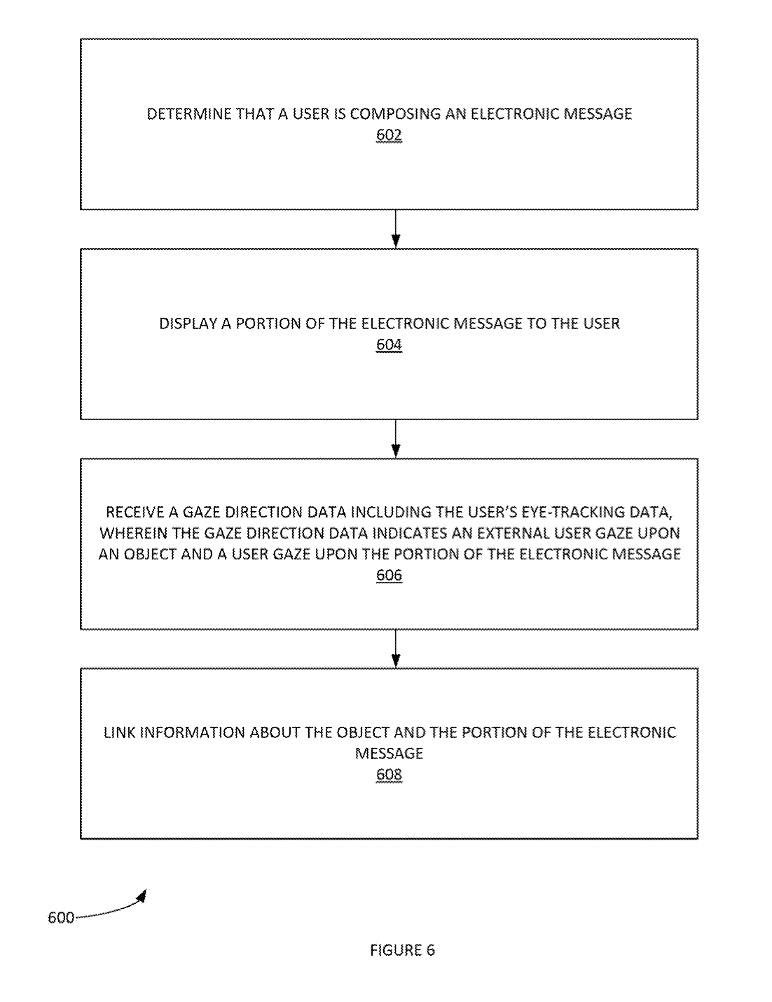

FIG. 6 depicts a process 600 of composing an electronic message, according to some embodiments. In step 602, it is determined that a user is composing an electronic message (e.g. can include media elements in some embodiments). In step 604, a portion of the electronic message can be displayed to the user. In step 606, a user gaze direction data can be received (e.g. the user can be looking at a physical object through an OMHD with an eye-tracking system). The user-gaze data can indicate an external user gaze upon an object and/or a user gaze upon a portion of the electronic message. In step 608, information about the object (e.g., a digital image of the object, an identity of the object, sensor data about the object, etc.) can be linked to the portion of the electronic message.

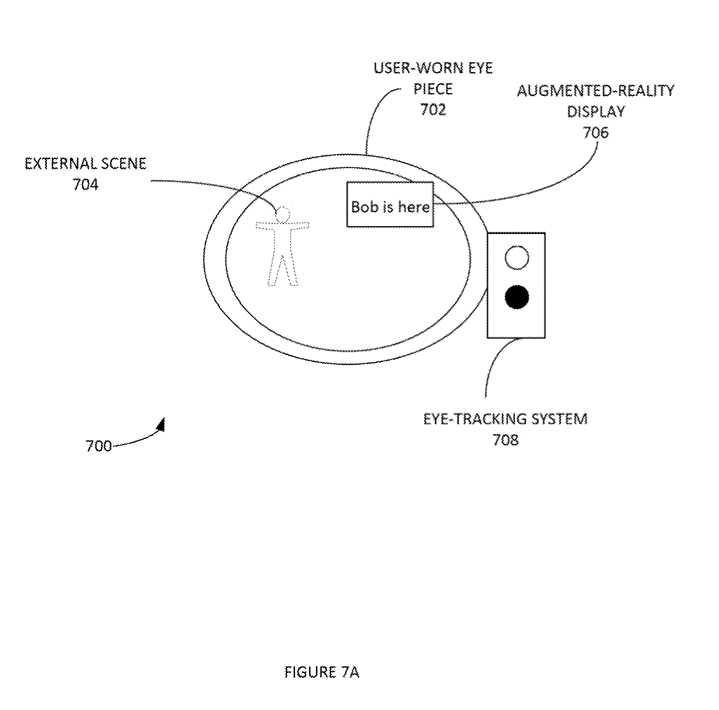

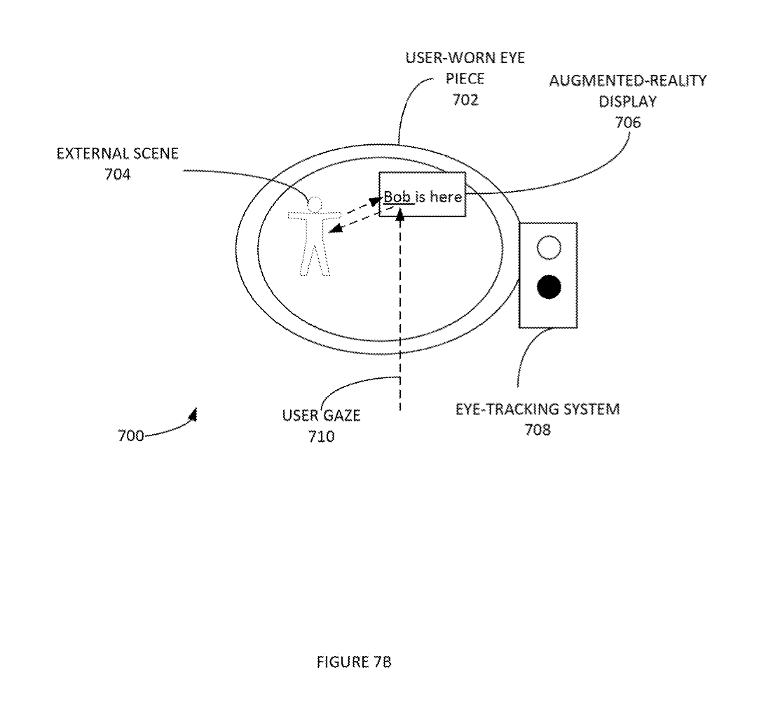

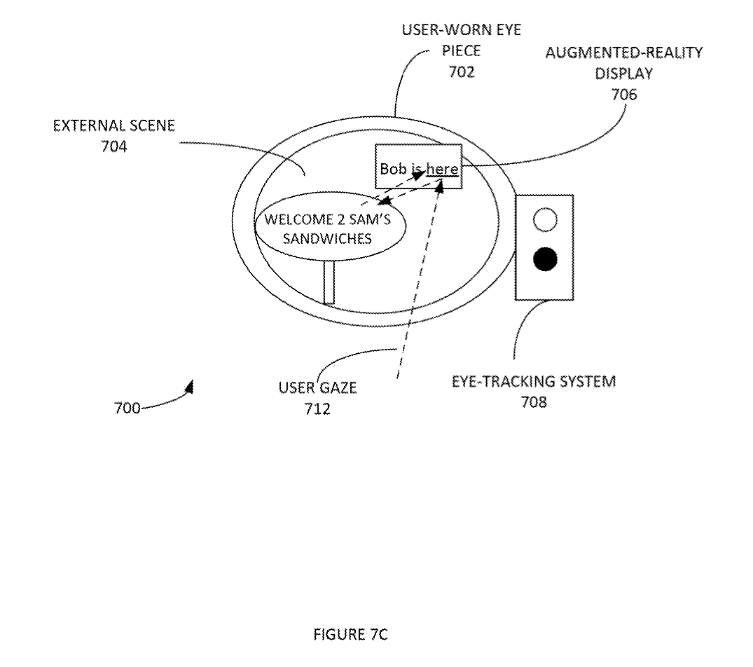

FIGS. 7A-C illustrate example methods for generating a context-enriched message with user eye-tracking data, according to some embodiments. In FIG. 7A, a portion of an OHMD 700 is provided including: a user-worn eye piece 702, an augmented-reality display 706 and an eye-tracking system 708. It is noted that OHMD 700 can include other elements such as those provided for augmented-reality glasses 202 in FIG. 2. In some embodiments, the aspects of OHMD 700 can be adapted for implementation with tablet computer 302 of FIG. 3 as well. A user can view an external scene 704 through a lens in user-worn eye piece 702, in the example, of FIG. 7A, external scene 704 can include a friend of the user named Bob. A computing system (e.g. computing system 208) coupled with OHMD 700 can include a text messaging functionality (and/or other messing functionality such as voice or video messaging). For example, a user can input the content of a text message by voice commands and/or input (and/or various touch inputs). For example, the user can set the computing device in a text messaging mode. The user can say the phrase, “Bob is here”. The computing device can translate the voice input to text with a voice-to-text module. Eye-tracking system 708 can obtained user gaze and other eye movement information as the user views external scene 704 and/or augmented-reality display 706. Augmented-reality display 706 can display images (e.g. augmented-reality images) from a projector in the computing system associated OMHD 700. For example, the projector can be coupled to an inside surface of a side-arm 114 and configured to project a display. For example, the project can project onto an inside surface of the lens element of user-worn eye piece 702. In another example, the projector can be configured to project onto a separate element coupled with user-worn eye piece 702 and viewable by the user.

FIG. 7B illustrates a process of linking information about Bob in the external scene 704 with a portion of the text message displayed in by augmented-reality display 706. User gaze 710 can be tracked by eye-tracking, system 708. User gaze 710 can be directed to the word ‘Bob’ in the text message for a specified period of time. Upon obtaining the user gaze 710 for the specified period of time, the display of the word ‘Bob’ can be modified to indicate that the user can then look at an object in external scene 704. User gaze 710 can then be directed to the physical Bob in the external scene. An outward facing camera in the computing, system can obtain images of Bob. Other sensors in the computing device coupled with OMHD 700 (and/or other computing device communicatively coupled with the computing, device of OMHD 700) can also obtained information about Bob and/or Bob's physical environment. An indication (e.g. a sound, a visual cue in the augmented-reality display 706, etc.) can be provided to the user indicating that information about physical Bob can be obtained. In one embodiment, the information about the physical Bob can then be linked to the text message portion ‘Bob’. In other embodiments, additional steps may be required to implement the link. For example, user gaze 710 can then be returned to the text message portion ‘Bob’ for a specified period before the link is implemented.

In some embodiments, additional information about Bob (e.g. social network data, other image data previously obtained by a camera system in the computing device coupled with OHMD 700, etc.) can be linked to the text message by a server-side application prior to sending the information to a destination, image recognition algorithms can be performed on any object in external scene 704. The result of the image recognition algorithm can be linked to an indicated portion of the text message.

FIG. 7C illustrates a process of linking information about a sign in the external scene 704 with a portion of the text message displayed in by augmented-reality display 706. User gaze 710 can be tracked by eye-tracking system 708. User gaze 710 can be directed to the word ‘here’ in the text message for a specified period of time. Upon obtaining the user gaze 710 for the specified period of time, the display of the word ‘here’ can be modified to indicate that the user can then look at an object in external scene 704. User gaze 710 can then be directed to an object in external scene 704 related to the term ‘here’ (e.g. a sign of a restaurant). An outward facing camera in the computing system can obtain images of object. Other sensors in the computing device coupled with OMHD 700 (and/or other computing device communicatively coupled with the computing device of OMHD 700) can also obtained information about the object. An indication (e.g. a sound, a visual cue in the augmented-reality display 706, etc.) can be provided to the user indicating that information about the object has been obtained. In one embodiment, the information about the object can then be automatically linked to the text message portion ‘here’. In other embodiments, additional steps may be required to implement the link. For example, user gaze 710 can then be returned, to the text message portion ‘here’ for a specified period before the link is implemented.

In some embodiments, additional information about object (e.g. social network data, user reviews, other image data previously obtained by a camera system in the computing device coupled with OHMD 700, etc.) can be linked to the text message by a server-side application prior to sending the information to a destination. Image recognition algorithms can be performed. On any object in external scene 704. The result of the image recognition algorithm can be linked to an indicated portion of the text message.

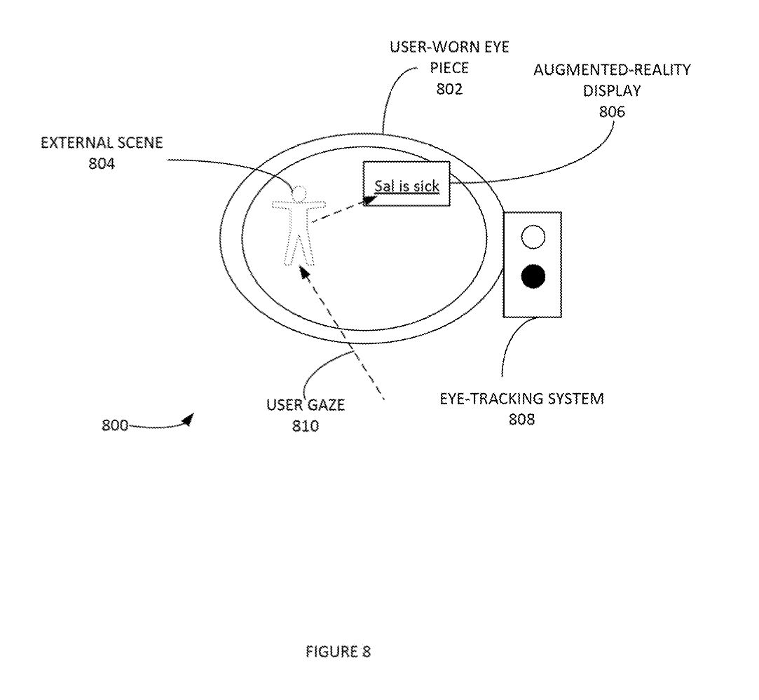

FIG. 8 illustrates another example method for generating a context-enriched message with user eye-tracking data, according to some embodiments. In FIG. 8, a portion of an OHMD 800 is provided including: a user-worn eye piece 802, an augmented-reality display 806 and an eye-tracking system 808. It is noted that OHMD 800 can include other elements such as those provided for augmented-reality glasses 202 in FIG. 2. In some embodiments, the aspects of OHMD 800 can be adapted for implementation with tablet computer 302 of FIG. 3 as well. A user can view an external scene 804 through a lens in user-worn eye piece 802. Eye-tracking system 808 can obtained user gaze and other eye movement information as the user views external scene 804 and/or augmented-reality display 806. Augmented-reality display 806 can display images (e.g. augmented-reality images) from a projector in the computing system associated OMHD 800. Eye-tracking system 808 can track user gaze 810 as the user looks at Sal. An external facing camera can obtained one or more digital images (e.g. can include a video) of Sal. This digital image(s) can be provided to an application (e.g. in a remote server, in an application in the local computing system coupled with the OMHD, etc.) for analysis. For example, the digital image(s) can be analyzed to determine biological state data about Sal (e.g. current blood pressure, pulse, respiratory rate, and the like). This information can be provided to the user as a message via augmented-reality display 806. User can utilized and/or modify this message (e.g., via voice commands). User can cause the biological state data for Sal to be linked to the message by moving her gaze from Sal to the message displayed in augmented-reality display 806. User can then cause the message to be communicated (e.g. to another user, to a medical service server, etc.).

Eye-tracking data of a user can be used for appending information to a text message. A text message can be obtained. For example, the text message may be generated by a text messaging application of a mobile device such as an augmented-reality pair of ‘smart glasses/goggles’, smartphone and/or tablet computer. User input may be with a virtual and/or physical keyboard or other means of user input such as a mouse, gaze-tracking, input, or the like. A bioresponse system, such as a set of sensors that may acquire bioresponse data from a user of the mobile device, may determine user expectations regarding information to be linked to the text message. For example, an eye-tracking system may be used to determine a user's interest in a term of the text message. A meaning of the term may be determined. An environmental attribute of the mobile device or an attribute of the user related to the meaning may be determined. The information may be obtained and appended to the text message. For example, a sensor, such as a mobile device sensor, may be used to obtain the environmental attribute of the mobile device or the attribute of the user. In another example, a server and/or database may be queried for information relevant to the term. The information may be included in the text message. For example, sensor data may be formatted as text and included in the text message if the text message is an SMS message. In another example, if the text message is an MMS message, the information may be formatted as a media type such as an audio recording, image, and/or video.

Regarding FIGS. 1, 4, 5, and 6, for purposes of simplicity of explanation, the one or more methodologies shown therein in the form of flow charts have been shown and described as a series of acts. It is to be understood and appreciated, however, that the subject innovation is not limited by the order of acts, as some acts may, in accordance with some embodiments, occur in a different order and/or concurrently with other acts that are shown and described herein. For example, those skilled in the art will understand and appreciate that a methodology could alternatively be represented as a series of interrelated states or events, such as in a state diagram. Moreover, not all illustrated acts may be required to implement a methodology in accordance with some embodiments.

In one example embodiment, a computing system may generate a display of a message (e.g. a text message; a multimedia message, etc.) on a display screen (e.g. the display screen of a pair of augmented-reality smart glasses) of a computing system. An eye tracking system may be coupled to the computing system. The eye tracking system may track eye movement of the user. The computing system may determine that a path associated with the eye movement of the user substantially matches a path associated between an external object (e.g. see FIGS. 7 A-C and/or 8 for example path patterns) and an element of the message on the display (e.g. a ‘drag and drop’—type operation utilizing eye-tracking data). The computing system may automatically obtain additional information about the external object (e.g. from digital cameras, object recognition algorithms, others sensors) once a specified path pattern is recognized. In some examples, various path patterns can be set to cause the computing system to automatically acquire information (e.g. with an object/image recognition application such as Google Goggles®) about an external object and link the information to an element of a message (e.g. user fixates on a term in the message than fixates on an external object then fixates again the word in the message). This additional information may be determined from an index that maps message elements with types of additional information. The additional information can be based on a meaning of the element of the message and/or its relationship to the external object. For example, if the message element is the word ‘here’ and the external object is a restaurant sign, then the additional information can be the location of the restaurant. Alternatively, if the message element is the words ‘great food’ and the external object is the same restaurant sign, then the additional information can be a third-party restaurant review obtained from a web server. In this way, the additional information can be dynamically determined based on such factors as a meaning of the message element, identity of the message element, context of the user, state of the user, and the like. This additional information may be determined from other sources such as those derived from a definition of the element of the message, machine-learning algorithms. etc. The external object may be identified if it is detected that the user fixates her gaze on the object for a specified period of time. The user may be provided a cue when the computing system prepared to receive the eye movement path from the object to the element of the message. Other cues may be provided indicating that the computing system has annotated the message element with the additional data about the external object.

### Additional Exemplary Environment and Architecture

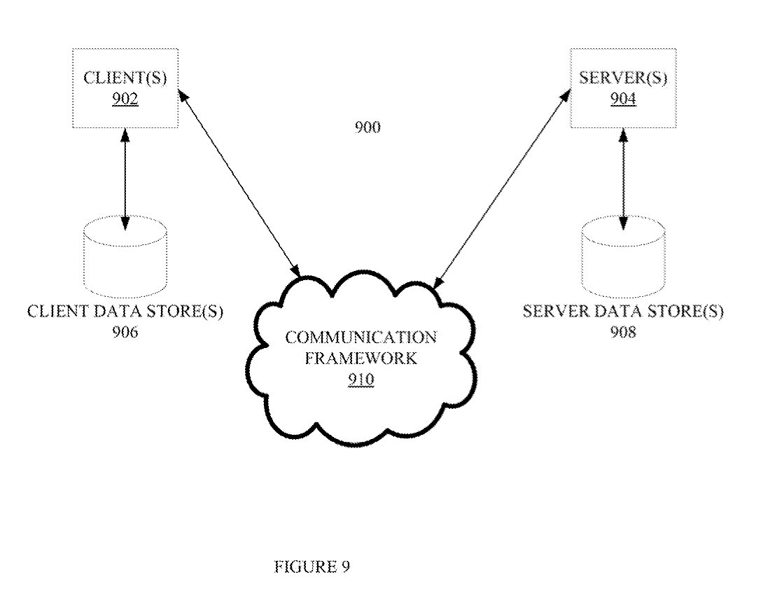

FIG. 9 illustrates another block diagram of a sample computing environment 900 with which embodiments may interact. The system 900 further illustrates a system that includes one or more clients 902. The client(s) 902 may be hardware and/or software (e.g., threads, processes, computing devices). The system 900 also includes one or more servers 904. The server(s) 904 may also the hardware and/or software (e.g., threads, processes, computing devices). One possible communication between a client 902 and a server 904 may be in the form of a data packet adapted to be transmitted between two or more computer processes. The system 900 includes a communication framework 910 that may be employed to facilitate communications between the client(s) 902 and the server(s) 904. The client(s) 902 are connected to one or more client data stores 906 that may be employed to store information local to the client s) 902. Similarly, the server(s) 904 are connected to one or more server data stores 908 that may be employed to store information local to the server(s) 904.

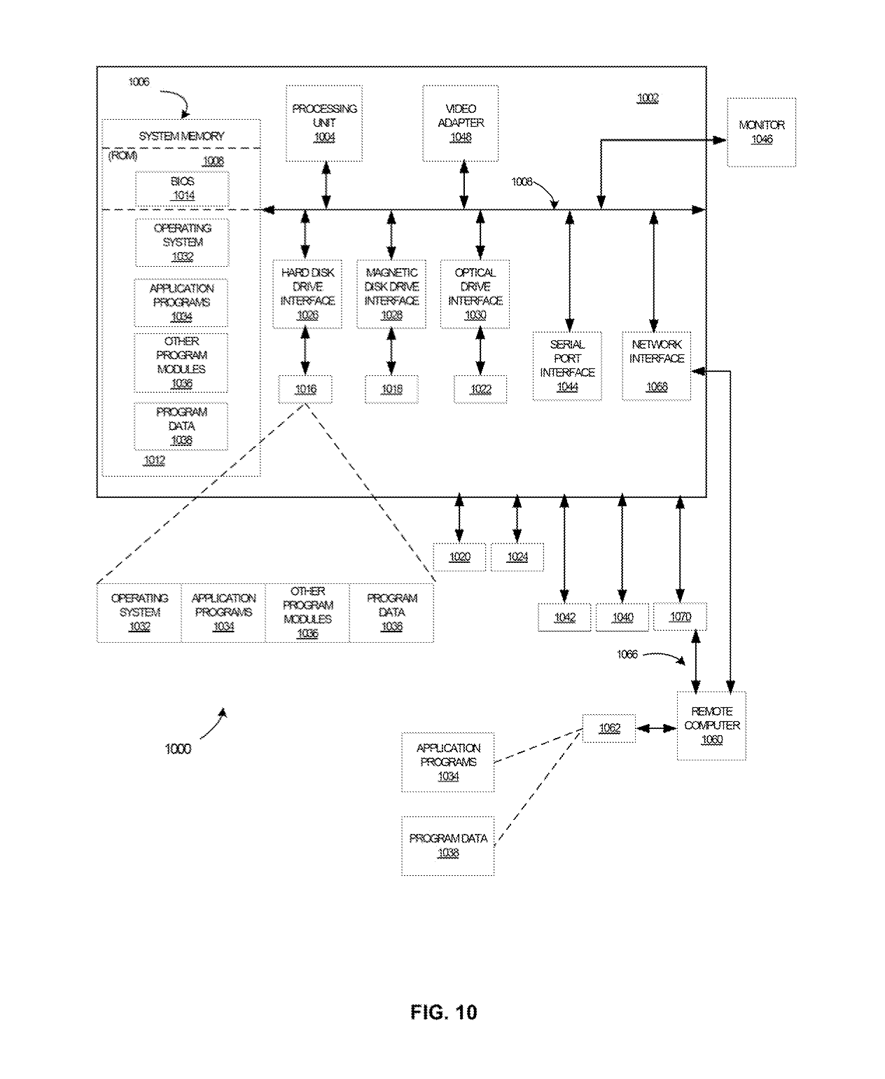

FIG. 10 is a diagram illustrating an exemplary system environment 1000 configured to perform any one of the above-described processes. The system includes a conventional computer 1002. Computer 1002 may include circuitry or other specialized hardware for carrying out some or all aspects of the processes. In some operational settings, computer 1002 may be configured as a system that includes one or more units, each of which is configured to carry out some aspects of the processes either in software, hardware, or some combination thereof. In FIG. 10, computer 1002 includes a processing unit 1004, a system memory 1006, and a system bus 1008 that couples various system components, including the system memory, to the processing unit 1004. The processing unit 1004 may be any commercially available or proprietary processor. In addition, the processing unit may be implemented as multi-processor formed of more than one processor, such as may be connected in parallel.

The system bus 1008 may be any of several types of bus structure including a memory bus or memory controller, a peripheral bus, and a local bus using any of a variety of conventional bus architectures such as PCI, VESA, Microchannel, ISA, EISA, or the like. The system memory 1006 includes read only memory (ROM) 1010 and random access memory (RAM) 1012. A basic input/output system (BIOS) 1014, containing the basic routines that help to transfer information between elements within the computer 1002, such as during startup, is stored in ROM 1010.

At least some values based on the results of the above-described processes can be saved for subsequent use. The computer 1002 also may include, for example, a hard disk drive 1016, a magnetic disk drive 1018, e.g., to read from or write to a removable disk 1020, and an optical disk drive 1022, e.g., for reading from or writing to a CD-ROM disk 1024 or other optical media. The hard disk drive 1016, magnetic disk drive 1018, and optical disk drive 1022 are connected to the system bus 1008 by a hard disk drive interface 1026, a magnetic disk drive interface 1028, and an optical drive interface 1030, respectively. The drives 1016-1022 and their associated computer-readable media may provide nonvolatile storage of data, data structures, computer-executable instructions, or the like, for the computer 1002. The computer program may be written, for example, in a general-purpose programming language (e.g., Pascal, C, C++, Java) or some specialized application-specific language. Although the description of computer-readable media above refers to a hard disk, a removable magnetic disk, and a CD, it should be appreciated by those skilled in the art that other types of media which are readable by a computer, such as magnetic cassettes, flash memory, digital video disks, Bernoulli cartridges, or the like, may also be used in the exemplary operating environment 1000, and further that any such media may contain computer-executable instructions for performing the methods of the embodiments.

A number of program modules may be stored in the drives 1016-1022 and RAM 1012, including an operating system 1032, one or more application programs 1034, other program modules 1036, and program data 1038. The operating system 1032 may be any suitable operating system or combination of operating systems. By way of example, the application programs 1034 and program modules 1036 may include a location annotation scheme in accordance with an aspect of an embodiment. In some embodiments, application programs may include eye-tracking modules, facial recognition modules, parsers (e.g., natural language parsers), lexical analysis modules, text-messaging argot dictionaries, dictionaries, learning systems, or the like.

A user may enter commands and information into the computer 1002 through one or more user input devices, such as a keyboard 1040 and a pointing device (e.g., a mouse 1042). Other input devices (not shown) may include a microphone, a game pad, a satellite dish, a wireless remote, a scanner, or the like. These and other input devices are often connected to the processing, unit 1004 through a serial port interface 1044 that is coupled to the system bus 1008, but may be connected by other interfaces, such as a parallel port, a game port, or a universal serial bus (USB). A monitor 1046 or other type of display device is also connected to the system bus 1008 via an interface, such as a video adapter 1048. In addition to the monitor 1046, the computer 1002 may include other peripheral output devices (not shown), such as speakers, printers, etc.

It is to be appreciated that the computer 1002 may operate in a networked environment using logical connections to one or more remote computers 1060. The remote computer 1060 may be a workstation, a server computer, a router, a peer device, or other common network node, and typically includes many or all of the elements described relative to the computer 1002, although for purposes of brevity, only a memory storage device 1062 is illustrated in FIG. 10. The logical connections depicted in FIG. 10 may include a local area network (LAN) 1064 and a wide area network (WAN) 1066. Such networking environments are commonplace in offices, enterprise-wide computer networks, intranets, and the Internet.

When used in a LAN networking environment, for example, the computer 1002 is connected to the local network 1064 through a network interface or adapter 1068. When used in a WAN networking environment, the computer 1002 typically includes a modem (e.g., telephone, DSL, cable, etc.) 1070, is connected to a communications server on the LAN, or has other means for establishing communications over the WAN 1066, such as the Internet. The modem 1070, which may be internal or external relative to the computer 1002, is connected to the system bus 1008 via the serial port interface 1044. In a networked environment, program modules (including application programs 1034) and/or program data 1038 may be stored in the remote memory storage device 1062. It will be appreciated that the network connections shown are exemplary and other means (e.g., wired or wireless) of establishing a communications link between the computers 1002 and 1060 may be used when carrying out an aspect of an embodiment.

In accordance with the practices of persons skilled in the art of computer programming, the embodiments have been described with reference to acts and symbolic representations of operations that are performed by a computer, such as the computer 1002 or remote computer 1060, unless otherwise indicated. Such acts and operations are sometimes referred to as being, computer-executed. It will be appreciated that the acts and symbolically represented operations include the manipulation by the processing unit 1004 of electrical signals representing data bits, which causes a resulting transformation or reduction of the electrical signal representation, and the maintenance of data hits at memory locations in the memory system (including the system memory 1006, hard drive 1016, floppy disks 1020, CDROM 1024, and remote memory 1062) to thereby reconfigure or otherwise alter the computer system's operation, as well as other processing of signals. The memory locations where such data bits are maintained are physical locations that have particular electrical, magnetic, or optical properties corresponding, to the data bits.

In some embodiments, system environment may include one or more sensors (not shown). In certain embodiments, a sensor may measure an attribute of a data environment, a computer environment, and a user environment, in addition to a physical environment. For example, in another embodiment, a sensor may also be a virtual device that measures an attribute of a virtual environment such as a gaming environment. Example sensors include, inter alia, global positioning system receivers, accelerometers, inclinometers, position sensors, barometers, WiFi sensors, RFID sensors, near-field communication (NFC) devices, gyroscopes, pressure sensors, pressure gauges, time pressure gauges, torque sensors, ohmmeters, thermometers, infrared sensors, microphones, image sensors (e.g., digital cameras), biosensors (e.g., photometric biosensors, electrochemical biosensors), an eye-tracking system (which may include digital camera(s), directable infrared lightings/lasers, accelerometers, or the like), capacitance sensors, radio antennas, galvanic skin sensors, GSR sensors, EEG devices, capacitance probes, or the like. System 1000 can be used, in some embodiments, to implements computing system 208. In some embodiments, system 1000 can include applications (e.g. a vital signs camera application) for measuring various user attributes such as breathing rate, pulse rate and/or blood oxygen saturation from digital image data. It is noted that digital images of the user (e.g. obtained from a user-facing camera in the eye-tracking system) and/or other people in the range of an outward facing camera can be obtained. In some embodiments, the application can analyze video dips record of a user's fingertip pressed against the lens of a digital camera in system 1000 to determine a breathing rate, pulse rate and/or blood oxygen saturation value.

In some embodiments, the system environment 1000 of FIG. 10 may be modified to operate as a mobile device. In addition to providing voice communications functionality, mobile device 1000 may be arranged to provide mobile packet data communications functionality in accordance with different types of cellular radiotelephone systems. Examples of cellular radiotelephone systems offering mobile packet data communications services may include GSM with GPRS systems (GSM/GPRS), CDMA systems, Enhanced Data Rates for Global Evolution (EDGE) systems, EV-DO systems, Evolution Data and Voice (EV-DV) systems, High Speed Downlink Packet Access (HSDPA) systems, High Speed Uplink Packet Access (HSUPA), 3GPP Long-Term Evolution (LTE), and so forth. Such a mobile device may be arranged to provide voice and/or data communications functionality in accordance with different types wireless network systems. Examples of wireless network systems may include a wireless local area network (WLAN) system, wireless metropolitan area network (WMAN) system, wireless wide area network (MAN) system, so forth. Examples of suitable wireless network systems offering data communication services may include the Institute of Electrical and Electronics Engineers (IEEE) 802.xx series of protocols, such as the IEEE 802.11a/b/g/n series of standard protocols and variants (also referred to as “WiFi”), the IEEE 802.16 series of standard protocols and variants (also referred to as “WiMAX”), the IEEE 802.20 series of standard protocols and variants, and so forth.

The mobile device may be arranged to perform data communications in accordance with different types of shorter-range wireless systems, such as a wireless personal area network (PAN) system. One example of a suitable wireless PAN system offering data communication services may include a Bluetooth system operating in accordance with the Bluetooth Special Interest Group series of protocols, including Bluetooth Specification versions v1.0, v1.1, v1.2, v2.0, or v2.0 with Enhanced Data Rate (EDR), as well as one or more Bluetooth Profiles, and so forth. Other examples may include systems using infrared, techniques or near-field communication techniques and protocols, such as electromagnetic induction (EMI) techniques. An example of EMI technique may include passive or active radiofrequency identification (RFID) protocols and devices.

Short Message Service (SMS) messaging is a form of communication supported by most mobile telephone service providers and widely available on various networks including Global System for Mobile Communications (GSM), Code Division Multiple Access (CDMA), Time Division Multiple Access (TDMA), third-generation (3G) networks, and fourth-generation (4G) networks. Versions of SMS messaging are described in GSM specifications such as GSM specification 03.40 “Digital cellular telecommunications system (Phase 2'); Technical realization of the Short Message Service” and GSM specification 03.38 “Digital cellular telecommunications system (Phase 2+); Alphabets and language-specific information.”

In general, SMS messages from a sender terminal may be transmitted to as Short Message Service Center (SMSC), which provides a store-and-forward mechanism far delivering the SMS message to one or more recipient terminals. Successful SMS message arrival may be announced by a vibration and/or a visual indication at the recipient terminal. In some cases, the SMS message may typically contain an SMS header including the message source (e.g., telephone number, message center, or email address) and a payload containing the text portion of the message. Generally, the payload of each SMS message is limited by the supporting network infrastructure and communication protocol to no more than 140 bytes which translates to 160 7-bit characters based on a default 128-character set defined in GSM specification 03.38, 140 8-hit characters, or 70 16-bit characters for languages such as Arabic, Chinese, Japanese, Korean, and other double-byte languages.

A long message having more than 140 bytes or 160 7-bit characters may be delivered as multiple separate SMS messages. In some eases, the SMS infrastructure may support concatenation allowing a long message to be sent and received as multiple concatenated SMS messages. In such cases, the payload of each concatenated SMS message is limited to 140 bytes but also includes a user data header (UDH) prior to the text portion of the message. The UDH contains segmentation information for allowing the recipient terminal to reassemble the multiple concatenated SMS messages into a single long message. In addition to alphanumeric characters, the text content of an SMS message may contain iconic characters (e.g., smiley characters) made up of a combination of standard punctuation marks such as a colon, dash, and open bracket for a smile.

Multimedia Messaging (MMS) technology may provide capabilities beyond those of SMS and allow terminals to send and receive multimedia messages including graphics, video, and audio dips. Unlike SMS, which may operate on the underlying, wireless network technology (e.g., GSM, CDMA, TDMA), MMS may use Internet Protocol (IP) technology and be designed to work with mobile packet data services such as General Packet Radio Service (GPRS) and Evolution Data Only/Evolution Data Optimized.

Although the present embodiments have been described with reference to specific example embodiments, various modifications and changes may be made to these embodiments without departing from the broader spirit and scope of the various embodiments. For example, the various devices, modules, etc., described herein may be enabled and operated using hardware circuitry, firmware, software, or any combination of hardware, firmware, and software (e.g., embodied in a machine-readable medium).

In addition, it will be appreciated that the various operations, processes, and methods disclosed herein may be embodied in a machine-readable medium and/or a machine-accessible medium compatible with a data processing, system (e.g., a computer system), and may be performed in any order (e.g., including using means for achieving the various operations). Accordingly, the specification and drawings are to be regarded in an illustrative rather than a restrictive sense. In some embodiments, the machine-readable medium may be a non-transitory form of machine-readable medium.

What is claimed as new and desired to be protected by Letters Patent of the United States is:

1. A method comprising:
receiving eye tracking information associated with eye movement of a user of a computing system from an eye tracking system coupled to a computing system, wherein the computing system is in a messaging mode of operation and is displaying an element of a message;
based on the eye tracking information, determining that a path associated with the eye movement associates an external object with a portion of the message; and
automatically associating an information about the external object with the portion of the message.

2. The method of claim 1, wherein the message comprises a text message.

3. The method of claim 1 further comprising:
determining the information about the external object based on a meaning of the external object.

4. The method of claim 3 further comprising:
identifying the external object with an image recognition algorithm.

5. The method of claim 1, wherein the computing system comprises a user-wearable computer with an outward facing camera.

6. The method of claim 1 further comprising:
rendering the message on a head-mounted display (HMD) coupled to the user-wearable computer.

7. The method of claim 1 further comprising:
communicating the message and the information about the external object to another user's computing device.

8. The method of claim 1 further comprising:
obtaining a digital image of the external object.

9. The method of claim 8 further comprising:
wherein the external object comprises a person, and wherein the portion of the text message refers to a health state of the person,
based on the digital image, determining a respiratory rate, heart rate or blood pressure value of the person; and
automatically annotating the portion of the text message with the respiratory rate, heart rate or blood pressure value of the person.
